(19) United States
(12) Patent Application Publication
(10) Pub. No.: US 2009/0159764 A1
(43) Pub. Date: Jun. 25, 2009

(54) Extension Mechanism for an Actuator

(76) Inventors: Yung-Tsai CHUO, Taichung (TW); Chiung-Yi Chiang, Taichung (TW)

Correspondence Address: Dr. BANGER SHIA, 102 Lindencrest Ct., Sugar Land, TX, 77479-5201, US

(21) Appl. No.: 11/961,925

(22) Filed: Dec. 20, 2007

(51) Int. Cl. F16M 11/26

(52) U.S. Cl. 248/188.5

(57) ABSTRACT

An extension mechanism for an actuator comprises a telescopic assembly, a motor and an extension assembly. The motor and the extension assembly are respectively disposed in the telescopic assembly, and the motor is fixed at one end of the telescopic assembly. The extension assembly is connected by a plurality of X-shaped pivot members, and every two rods are pivotally connected together to form an X-shaped pivot member. The extension assembly is respectively connected to the sleeves. The motor is used to drive the extension assembly to extend and retract, thus causing the extension and retraction of the telescopic assembly.

### BACKGROUND OF THE INVENTION

1. Field of the Invention

The present invention relates to an actuator, and more particularly to an extension mechanism for an actuator.

2. Description of the Prior Art

Actuator has a wide range of application, it mainly utilizes an inner motor to drive the body to extend and retract, so as to drive other mechanisms to move. A conventional art of an actuator is disclosed in U.S. Pat. No. 6,880,416, wherein a motor and three screws are disposed in the three-section telescopic assembly. The three screws are respectively connected to each sleeve of the telescopic assembly. The motor drives the screws to move axially, thus causing the extension and retraction of the telescopic assembly.

Another actuator is disclosed in EP Patent No. 0,982,018, which comprises a motor, a screw and a block disposed in the three-section telescopic assembly. The motor drives the screw to rotate, then the screw drives the sleeve provided with the block to move, and finally the block serves as a traveling block to move another sleeve, thus causing the extension and retraction of the telescopic assembly.

It is to be noted that the conventional actuator must utilize a screw to cause the extension and retraction of the telescopic assembly, and it rarely utilizes other methods.

The present invention has arisen to mitigate and/or obviate the afore-described disadvantages.

### SUMMARY OF THE INVENTION

The primary objective of the present invention is to provide an extension mechanism for an actuator which utilizes an extension assembly to cause the extension and retraction of the telescopic assembly.

To achieve the abovementioned objective, the extension mechanism for an actuator comprises a telescopic assembly, a motor and an extension assembly, wherein the telescopic assembly includes, sequentially from outside to inside, an outer sleeve, a mid sleeve, and an inner sleeve which are telescopically interconnected to one another. The motor and the extension assembly are both disposed in the telescopic assembly, and the motor is fixed at one end of the telescopic assembly. The extension assembly includes a plurality of rods, and every two rods are pivotally connected together to form an X-shaped pivot member. The pivot members are pivotally connected with each other in the same direction. The pivot members are connected in such a manner that both ends of the respective rods of one pivot member are pivotally connected to the corresponding ends of the respective rods of the adjacent pivot member. The extension assembly is connected to the sleeves, and the two ends at one end of the extension assembly are driven by the motor to move towards or away from each other, so as to control the extension or retraction of the extension assembly, thus causing the extension and retraction of the telescopic assembly.

It is apparent from the above that the motor drives the two ends at one end of the extension assembly to move, so as to cause the extension and retraction of the extension assembly and synchronously cause the extension and retraction of the telescopic assembly.

Moreover, the structure that the motor drives the extension assembly to extend and retract can make the motor drive a motor belt wheel to rotate. The motor belt wheel respectively drives two gears to rotate in the same direction by two belts, wherein one of the gears is engaged with a rack which is slideably disposed in the telescopic assembly, the other one of the gears is engaged with the other rack via the steering gear, and the two racks are also respectively connected to the two ends at one end of the extension assembly, so as to drive the two ends to move towards or away from each other when the motor drives the motor belt wheel to rotate.

### BRIEF DESCRIPTION OF THE DRAWINGS

FIG. 1 is a perspective view in accordance with the preferred embodiment of the present invention;

FIG. 2 is an interior illustrative view in accordance with the preferred embodiment of the present invention;

FIG. 3 is an operational view in accordance with the embodiment of the present invention; and

FIG. 4 is an illustrative view showing the extension and retraction of the actuator in accordance with the embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

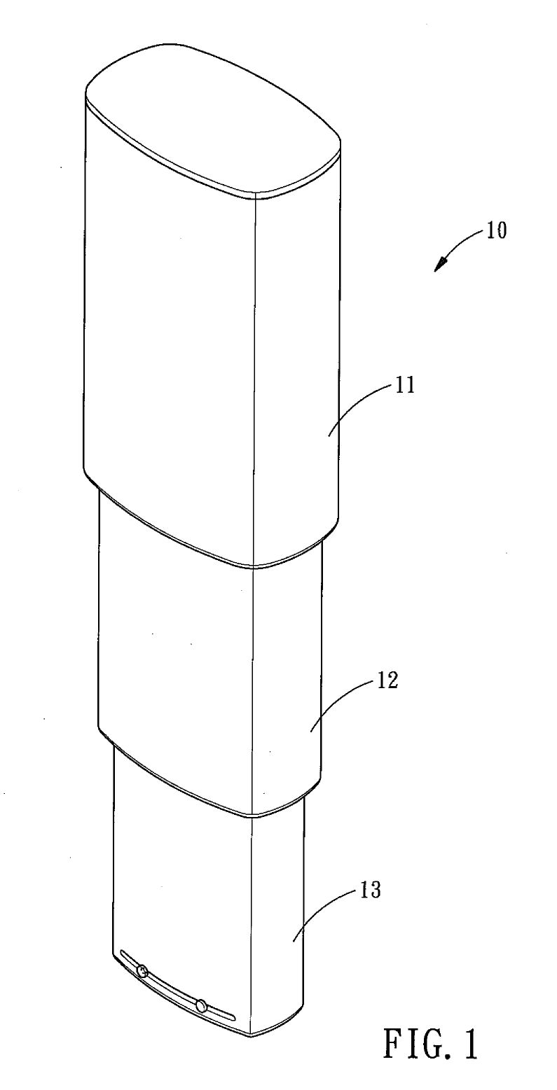

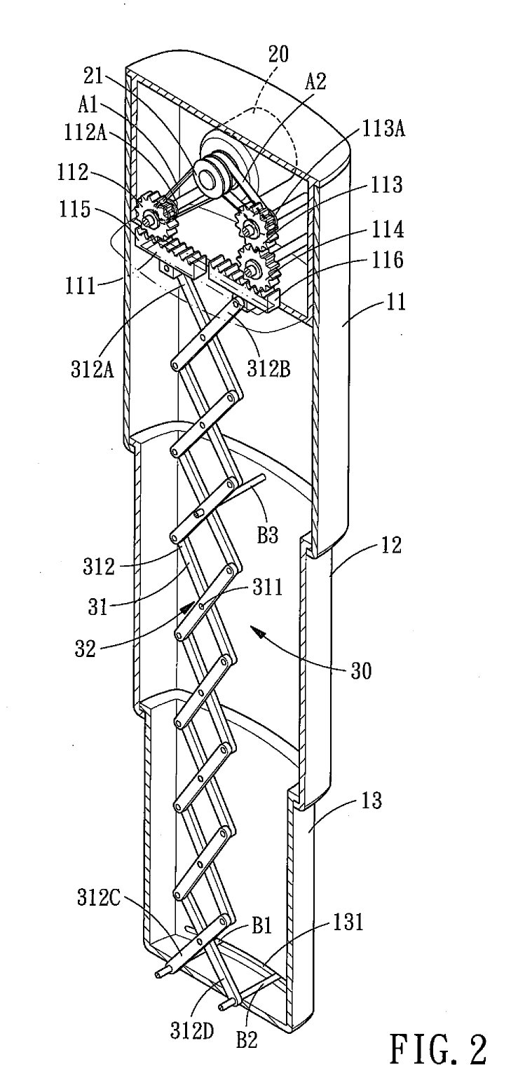

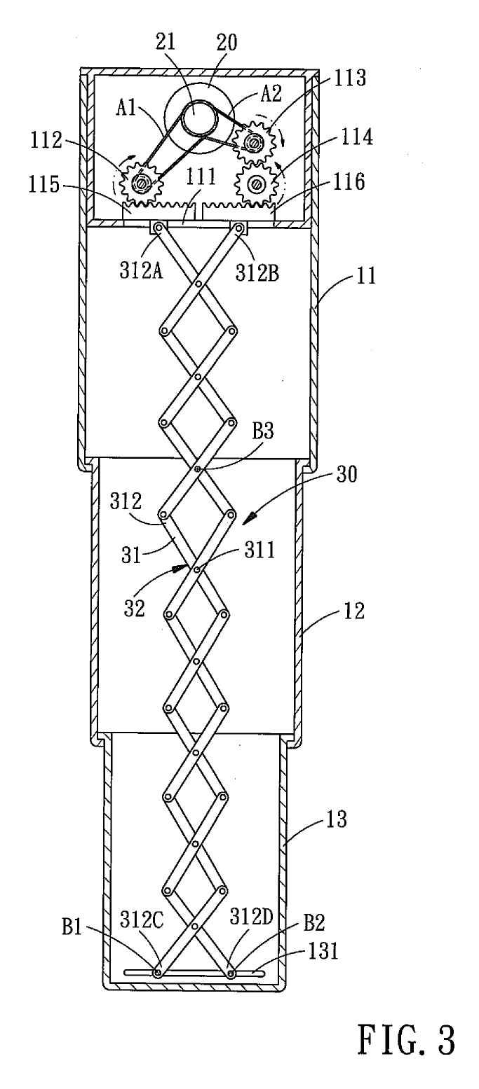

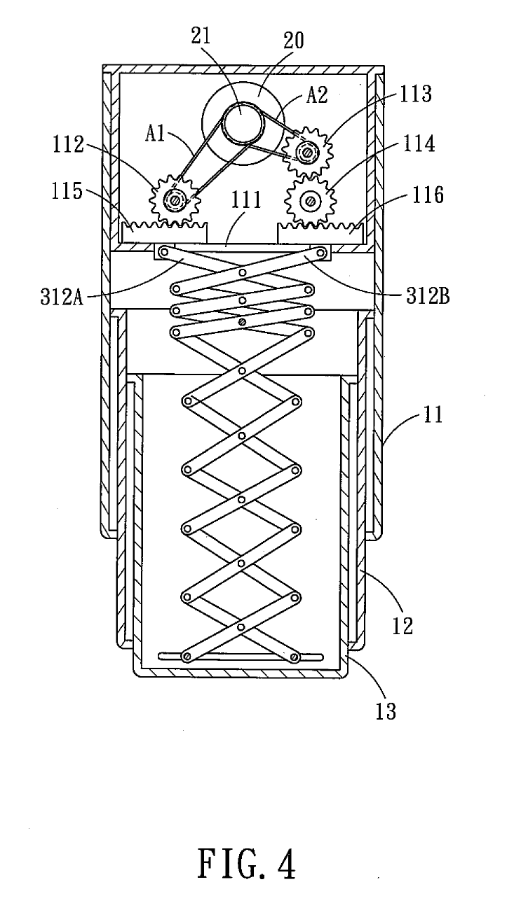

Referring to FIGS. 1-4, an extension mechanism for an actuator in accordance with the preferred embodiment of the present invention is shown and comprises: a telescopic assembly 10, a motor 20, and an extension assembly 30.

The telescopic assembly 10 includes, sequentially from outside to inside, an outer sleeve 11, a mid sleeve 12, and an inner sleeve 13 which are telescopically interconnected to one another. A slideway 111 whose extension direction is vertical to an assembly direction of the sleeves 11, 12, 13 is disposed inside an outer sleeve 11. Two gears 112, 113, a steering gear 114 and two racks 115, 116 are disposed in the sleeve 11. The two gears 112, 113 are rotatablely disposed in the sleeve 11 and coaxially connected to a belt wheel 112A, 113A, respectively. The steering gear 114 is rotatablely disposed in the sleeve 11 and engaged with the gear 113. The two racks 115, 116 are slideably disposed on the slideway 111 and engaged with the gear 112 and the steering gear 114, respectively. An elongated slot 131 is formed in the surface of the inner sleeve 13, and the extension direction of the slot 131 is vertical to the assembly direction of the three sleeves 11, 12, 13.

The motor 20 is fixed in the outer sleeve 11 of the telescopic assembly 10, and a motor belt wheel 21 is disposed on the rotation spindle (not shown) of the motor 20. Two adjacent belts A1, A2 are wound around the motor belt wheel 21 along the rotation spindle thereof, and the two belts A1, A2 are also respectively wound around the two belt wheels 112A, 113A in the outer sleeve 11 of the telescopic assembly 10.

The extension assembly 30 is disposed in the telescopic assembly 10 and connected to the three sleeves 11, 12, 13, respectively. The extension assembly 30 includes a plurality of rods 31. Every two rods 31 are pivotally connected together via a pivot node 311 at the center of the respective rods 31 to form an X-shaped pivot member 32. The pivot members 32 are pivotally connected with each other in the same direction. The pivot members 32 are connected in such a manner that both ends 312 of the respective rods 31 of one pivot member 32 are pivotally connected to the corresponding ends 312 of the respective rods 31 of the adjacent pivot member 32. The two ends 312A, 312B at one end of the extension assembly 30 are pivotally connected to the two racks 115, 116 in the outer sleeve 11 of the telescopic assembly 10, respectively. The two ends 312C, 312D at the other end of the extension assembly 30 are connected to the sleeve 13, respectively, by a pin B1 and B2 inserted in the slot 131 of the sleeve 13. Additionally, a pivot member 32 of the extension assembly 30 which is located correspondingly to the mid sleeve 12 is fixed on the sleeve 12 by a pin B3 inserted in the pivot node 311.

The motor 20 drives the belt gear 21 to rotate, so as to drive the two belts A1, A2 to move. The two belts A1, A2 also drive the two belt wheels 112A, 113A to rotate. When the two gears 112, 113 rotates with the two belt wheels 112A, 113A synchronously, the gear 112 will be engaged with the rack 115 and drive it to slide along the slideway 111. Meanwhile, the gear 113 will drive the rack 116 to slide on the slideway 111 via the steering gear 114. Since the two belts A1, A2 move in the same direction, the two belt wheels 112A, 113A and the two gears 112, 113 will also move in the same direction. However, the gear 112 is directly engaged with the rack 115, the gear 113 is engaged with the rack 116 via the steering gear 114, so the rack 115 and the rack 116 move in opposite directions.

Therefore, the motor 20 can drive the two racks 115, 116 to move towards or away from each other and drive the two ends 312A, 312B of the extension assembly 30 to move towards or away from each other, so as to control the extension or retraction of the extension assembly 30 Additionally, the extension assembly 30 is connected to the mid sleeve 12 via a pin B3 and connected to the outer sleeve 13 via the two ends 312C, 312D, so as to synchronously cause the extension and retraction of the telescopic assembly 10. When the two ends 312A, 312B move towards each other, the extension assembly 30 and the telescopic assembly 10 extend synchronously, and when the two ends 312A, 312B move away from each other, the extension assembly 30 and the telescopic assembly 10 retract synchronously.

While we have shown and described various embodiments in accordance with the present invention, it is clear to those skilled in the art that further embodiments may be made without departing from the scope of the present invention.

What is claimed is:

1. An extension mechanism for an actuator comprising:
a telescopic assembly including a plurality of sleeves telescopically interconnected to one another;
a motor being disposed in the telescopic assembly and fixed at one end of the telescopic assembly; and
an extension assembly being disposed in the telescopic assembly and connected to sleeves, respectively, the extension assembly including a plurality of rods, every two rods pivotally being connected together to form an X-shaped pivot member, the pivot members being pivotally connected with each other in a same direction, the pivot members being connected in such a manner that both ends of the respective rods of one pivot member are pivotally connected to corresponding ends of the respective rods of a adjacent pivot member, and two ends at one end of the extension assembly moving towards or away from each other.

2. The extension mechanism for an actuator as claimed in claim 1, wherein a slideway whose extension direction is vertical to an assembly direction of the sleeves is disposed inside an outmost sleeve, two gears, a steering gear and two racks are disposed in the outmost sleeve, the two gears are rotatablely disposed in the outmost sleeve and coaxially connected to a belt wheel, respectively, the steering gear is rotatablely disposed in the outmost sleeve and engaged with one of the gears, the two racks are slideably disposed on the slideway and engaged with the other one of the gears and the steering gear, the motor is fixed in the outmost sleeve, a motor belt wheel is disposed on a rotation spindle of the motor, two adjacent belts are wound around the motor belt wheel along the rotation spindle and also respectively wound around the two belt wheels in the outmost sleeve, and the two ends at one end of the extension assembly are pivotally connected to the two racks of the outmost sleeve, respectively.

3. The extension mechanism for an actuator as claimed in claim 1, wherein an elongated slot is formed in a surface of an innermost sleeve of the telescopic assembly, an extension direction of the slot is vertical to the assembly direction of the sleeves, the two ends at the other end of the extension assembly are connected to the sleeve, respectively, by a pin inserted in the slot of the sleeve.

4. The extension mechanism for an actuator as claimed in claim 1, wherein every two rods are pivotally connected together via a pivot node at a center of the respective rods to form an X-shaped pivot member.

5. The extension mechanism for an actuator as claimed in claim 1, wherein the telescopic assembly includes, sequentially from outside to inside, an outer sleeve, a mid sleeve, and an inner sleeve which are telescopically interconnected to one another.

6. The extension mechanism for an actuator as claimed in claim 1, wherein the telescopic assembly includes, sequentially from outside to inside, an outer sleeve, a mid sleeve, and an inner sleeve which are telescopically interconnected to one another, a slideway whose extension direction is vertical to an assembly direction of the sleeves is disposed inside the outer sleeve, two gears, a steering gear and two racks are disposed in the outer sleeve, the two gears are rotatablely disposed in the outer sleeve and coaxially connected to a belt wheel, respectively, the steering gear is rotatablely disposed in the outer sleeve and engaged with one of the gears, the two racks are slideably disposed on the slideway and engaged with the other one of the gears and the steering gear, the motor is fixed in the outer sleeve, the motor belt wheel is disposed on the rotation spindle of the motor, two adjacent belts are wound around the motor belt wheel along the rotation spindle and also respectively wound around the two belt wheels in the outer sleeve, and the two ends at one end of the extension assembly are pivotally connected to the two racks of the outer sleeve, respectively.

7. The extension mechanism for an actuator as claimed in claim 1, wherein the telescopic assembly includes, sequentially from outside to inside, an outer sleeve, a mid sleeve, and an inner sleeve which are telescopically interconnected to one another, an elongated slot is formed in the surface of the inner sleeve, and an extension direction of the slot is vertical to the assembly direction of the three sleeves, every two rods are pivotally connected together via a pivot node to form a pivot member, a pivot member of the extension assembly which is located correspondingly to the sleeve is fixed on the sleeve by a pin inserted in the pivot node, and the two ends at the other end of the extension assembly are connected to the inner sleeve, respectively, by a pin inserted in the slot of the inner sleeve.

8. The extension mechanism for an actuator as claimed in claim 1, wherein the telescopic assembly includes, sequentially from outside to inside, an outer sleeve, a mid sleeve, and an inner sleeve which are telescopically interconnected to one another, a slideway whose extension direction is vertical to an assembly direction of the sleeves is disposed inside the outer sleeve, two gears, a steering gear and two racks are disposed in the outer sleeve, the two gears are rotatablely disposed in the outer sleeve and coaxially connected to a belt wheel, respectively, the steering gear is rotatablely disposed in the sleeve and engaged with one of the gears, the two racks are slideably disposed on the slideway and engaged with the other one of the gears and the steering gear, an elongated slot is formed in the surface of the inner sleeve, and the extension direction of the slot is vertical to the assembly direction of the three sleeves, the motor is fixed in the outer sleeve, a motor belt wheel is disposed on the rotation spindle of the motor, two adjacent belts are wound around the motor belt wheel along the rotation spindle and also respectively wound around the two belt wheels in the outer sleeve, every two rods of the extension assembly pivotally connected together via a pivot node at the center of the respective rods to form an X-shaped pivot member, and the two ends at one end of the extension assembly are pivotally connected to the two racks of the outer sleeve, a pivot member of the extension assembly which is located correspondingly to a middle sleeve is fixed on the sleeve by a pin inserted in the pivot node, and the two ends at the other end of the extension assembly are connected to the sleeve, respectively, by a pin inserted in the slot of the inner sleeve.
